(19) United States
(12) Patent Application Publication
(10) Pub. No.: US 2011/0045131 A1
(43) Pub. Date: Feb. 24, 2011

(54) PROCESS AND SYSTEM FOR COOKING CHEESE WITH A SUBSTANTIALLY INVARIABLE ENERGY TRANSFER

(75) Inventor: Steve James Ejnik, New London, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: RELCO UNISYSTEMS CORPORATION, Wilmar, MN (US)

(21) Appl. No.: 12/439,574

(22) PCT Filed: Aug. 30, 2007
(86) PCT No.: PCT/US07/77241

§ 371 Date: Oct. 13, 2009

Related U.S. Application Data
(60) Provisional application No. 60/842,063, filed on Sep. 1, 2006.

(51) Int. Cl. A23C 19/00

(52) U.S. Cl. 426/36; 99/453

(57) ABSTRACT

A process for transferring energy to the contents of a vat. An embodiment transfers an amount of heat energy needed to heat cheese curd and whey inside the vat according to a specified time and temperature. An energy substrate, such as steam and/or water, carries heat energy to a vat jacket. The embodiment calculates the total process energy required to be transferred to the vat contents to cook the cheese in accordance with a recipe. The total process energy is a function of the energy input to the vat minus the energy output from the vat. Small losses of energy from the vat to the atmosphere occur. These small losses are accounted for by use of historical efficiency data for each vat. The historical efficiency is continuously monitored and any deviation from the historical efficiency is factored into the energy transfer calculation for subsequent cheese batches.

### FIELD OF TECHNOLOGY

The technology described in this specification relates to a process and system for cooking cheese with a substantially invariable energy transfer.

### BACKGROUND

Cheese is a solid food, consisting of water, fat, protein, carbohydrates, minerals, and other trace substances. It is prepared from the pressed curd of milk. Cheese is made by coagulating milk, cutting and heating the curd to express the whey, and pressing and ripening the cheese. The cheese making process begins with liquid, pasteurized cheese milk or unpasteurized cheese milk, which becomes a blend of curds and whey. Rennet, a milk-coagulating enzyme, is added to the cheese milk to start the process of curdling/coagulating the cheese milk. The curdled cheese milk is a solid gelatinous mass. After it is cut with sharp knives to express the whey it is cooked by heating in a vat to further release the whey.

The process and system 10 (alternatively referred to herein as “process 10,” or “system 10”) for cooking cheese by transferring a substantially invariable heat energy transfer to cut, gelatinous, curdled cheese milk (the “vat contents 11a”) in a vat 11 is the subject of this specification.

FIG. 1 is a schematic illustration of a prior art system 23 for cooking cheese. Prior art system 23 includes vat 11. Vat 11 has a jacket 16 for circulation of heat energy in a steam or water substrate. An agitator rotates within vat 11 for constant mixing of vat contents 11 a during cooking and thereafter during the cooked, cheese cool down period. Steam is circulated through system 23. The steam originates from steam boiler 12. It travels via steam line 13 to steam flow valve 14, through steam flow valve 14, through steam lines 13a and 13b, and then into vat jacket 16. The steam circulates through vat jacket 16, exits out condensate line 17, travels to condensate tank 21, and is pumped by pump 20, via return line 17a, back to boiler 12. Prior art temperature sensor 18A is inserted into vat 11 to monitor the temperature of the cooking cheese. The output of sensor 18A is sent via temperature feedback wire 19 to a programmable logic control device (“PLC 22”). Steam flow valve 14 controls steam flowing through steam lines 13, 13a, and 13b and temperature element 18a constantly sends the temperature of the vat contents 11a, via wire 19, to PLC 22. PLC 22 determines, at each given point in time, the amount of steam that should flow through steam lines 13, 13a, and 13b based upon the actual temperature of the cooking cheese from temperature sensor 18A and the actual flow of steam through steam flow valve 14. PLC signals steam flow valve 14, via wire 19a, to adjust steam flow through steam lines 13, 13a, and 13b as a function of the rising temperature of the vat contents 11a, as indicated by temperature element 18a. When PLC 22 senses from temperature element 18a that vat contents 11a has reached its recipe set point (i.e., the not to exceed temperature), PLC 22 signals steam flow valve 14 to close, or partially close, depending upon the parameters set by the recipe. PLC 22 uses stored instructions and recipe parameters that correlate the real time steam flow and temperature indications with a corresponding steam flow required to cook vat contents 11a in accordance with the cheese recipe. This is a constantly modulated process.

As can be understood from the foregoing, the prior art technique of assuring adequate cooking of cheese is based upon monitoring the temperature of the cheese throughout the cook cycle. The cheese temperature, a process variable, is fed back to the heat energy delivery system. The heat energy delivery system, the control variable, sets the amount of heat delivered to the cooking cheese as a function of the changing cheese temperature or the rate of change of the temperature. The feedback system is a proportional, integral, derivative loop. It is designed to eventually return the temperature of vat contents 11a to the temperature dictated by the cheese recipe, i. e., the set point. The feedback method is used for cooking cheese curd and whey in both open and closed cheese processing vats.

Temperature indications are obtained from a temperature sensor 18A placed directly in the cheese vat contents 11a or on the surface of the vat wall.

During initial ramp up of the cook cycle, beginning for example at a vat content 11a temperature of 88° F., temperature sensor 18A output is not proportional to the required heating energy. The temperature indication either triggers the heat delivery control system to provide too much or too little energy. Yet the desired temperature rise can be very linear over time. Cheese processors often correct for this lack of a direct correlation between cheese temperature and the required heat by ignoring temperature indications and setting the heat flow device, such as a steam flow valve 14, at a fixed position. However, this can result in high standard deviations from the desired energy input. Moreover, the excessive heat spikes cause fat losses in the whey and inconsistent starter culture growth curves. The end result is lost cheese yield due to lost fat from whey and high standard deviations in cheese moisture and the fat dry basis.

### SUMMARY OF EMBODIMENTS

An embodiment of process 10 for cooking cheese with a substantially invariable energy transfer comprises the steps of providing a recipe for making cheese; determining total process energy required to cook cheese ingredients according to the recipe; and transferring total process energy to the ingredients. The recipe comprises the temperature of ingredients at start of cook cycle; temperature of ingredients at end of cook cycle; elapsed time from start to end of cook cycle; and the mass of the ingredients. The ingredients are comprised primarily of curds and whey. Determination of the total process energy comprises calculating net energy as the product of the mass of the ingredients multiplied by the specific heat of the ingredients multiplied by the difference between the temperature of the ingredients at end of the cook cycle and the temperature of the ingredients at the start of the cook cycle. Determination of total process energy also comprises calculating lost water enthalpy energy, lost condensate enthalpy energy, and correction factor energy. Total process energy is the sum of net energy, lost water enthalpy energy, lost condensate enthalpy energy, and correction factor energy. A steady-state energy flow rate is determined by dividing the total process energy by the recipe cook time. The total process energy is transported by saturated steam at a pre-determined temperature to the ingredients.

An embodiment of a system 10 for making cheese is comprised of a container, such as a cheese cooking vat, for holding curds and whey ingredients. The container has a jacket with an input port and an output port. A source of energy, such as heat energy, is provided as is a means for transferring energy from a source, such as a boiler, to a substrate. The input port receives the substrate containing the energy. The jacket is adapted to transfer energy contained in the substrate to the container contents by being in contact with at least a portion of the container. The output port discharges the substrate, which after traveling through the jacket contains less energy than the energy contained in the substrate at the input port. The embodiment includes a means for determining the total process energy required to process the contents and a means for setting a constant rate of flow of total process energy through the jacket over a pre-determined period of time. The pre-determined period of time has a pre-determined start temperature and stop temperature.

### DRAWINGS

In the following figures, corresponding reference numerals indicate corresponding elements.

FIG. 1 is schematic illustration of a prior art system for cooking cheese; and

FIG. 2 is schematic illustration of an embodiment of system 10 for cooking cheese.

### DESCRIPTION OF EMBODIMENTS

Process 10 for cooking a vat 11 of curds and whey 34 to cheese by transferring a substantially constant, predetermined amount of heat energy to vat 11a contents during the entire cook cycle. It does not transfer heat energy to vat contents 11a based upon cheese temperature, as does the prior art cooking process. Energy transfer process 10 delivers a substantially steady-state stream of energy at all times during the cook cycle, in contrast to the prior art approach.

An embodiment of process 10 transfers energy to heat curds and whey 34 inside vat 11 according to the cooking time and temperature of cheese recipe 33. The transfer of energy uses a high, thermal mass substrate, such as steam and/or water, to carry energy units to a heating and/or cooling vat jacket 16. Process 10 determines total process energy 26 required to cook cheese by first calculating net energy 29 required to cook cheese in cooking system 10, on the assumption that system 10 is energy loss-free. The hypothetical loss free determination of net energy is adjusted for: (a) lost heat energy 27 due to lost water enthalpy energy 30 from vat 11 and other component inefficiencies; (b) lost heat energy 27 due to lost condensate enthalpy energy 31 exiting vat jacket 16 in the form of condensate or return liquid; and (c) heat correction factor energy 28 due to changes in historical efficiency data of system 10. Lost heat energy 27 is added to calculated net energy 29. Correction factor energy 28 is added to, or subtracted from, as the case may be, calculated net energy 29. The result is total process energy 26 required to cook ingredients 35.

Most heat loss due to inefficiencies in system 10 are the result of energy lost through the walls of vat 11 to the atmosphere, but there are also other parasitic losses. Heat loss due to system inefficiency is generally small. The loss is based upon historical efficiency data accumulated over one or more batches of cheese cooked in a specific vat 11. Historical efficiency data is specific to a single vat 11 and is not mixed with historical efficiency data for any other vat. Historical efficiency data for a vat of cooked cheese is compared to historical efficiency data accumulated for previous batches of cheese cooked in the same vat 11. In an embodiment, any change in historical efficiency data is used to update historical efficiency data. Updated historical efficiency data is factored into total process energy 26 for the next batch of cheese.

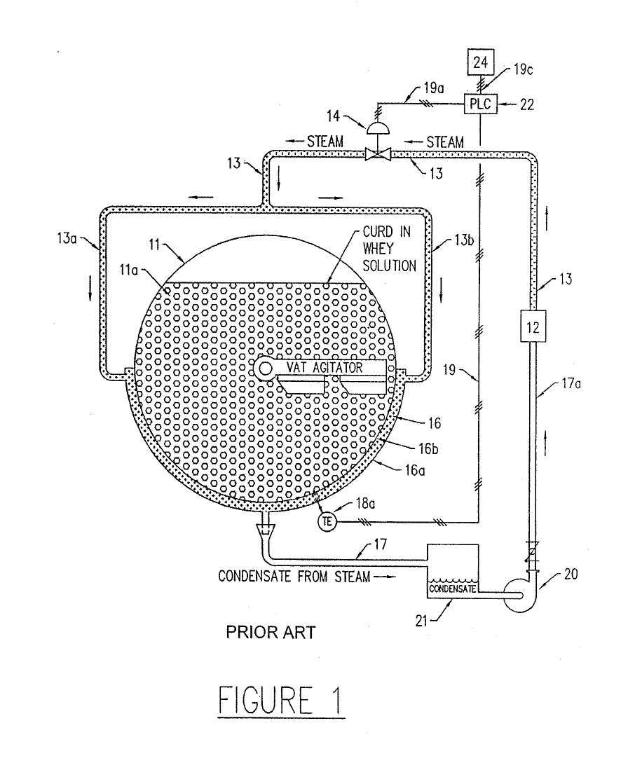

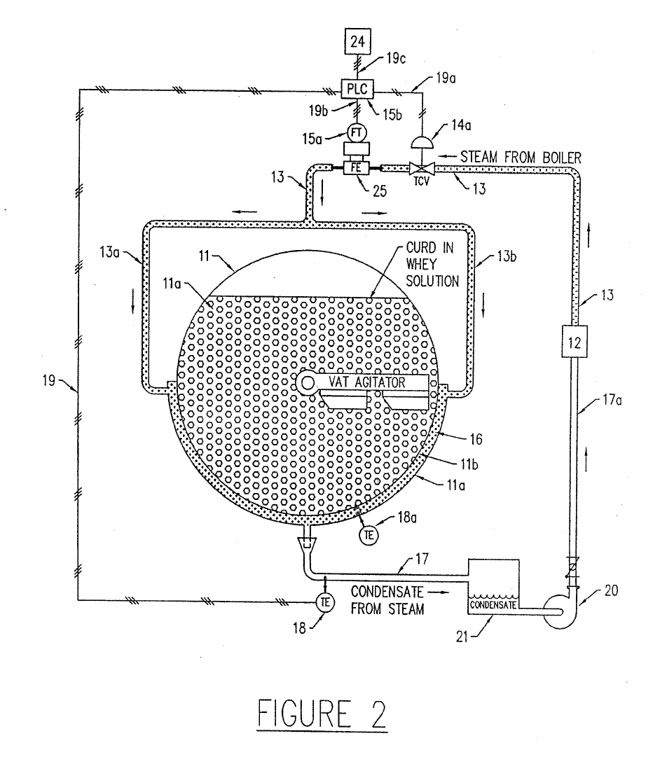

Total process energy 26 required to be transferred to vat contents 11a over the entire cook cycle time is determined prior to commencement of cooking. Among other factors, the amount of total process energy 26 depends upon recipe 33 cheese cook time, start temperature, end temperature, and the mass of ingredients 35. Ingredients 35 are primarily comprised of curds and whey 34. However, ingredients may also include various other components. Prior to cooking, system 10 is preset to deliver total process energy 26. Total process energy 26 is not delivered to system 10 in a single burst. Total process energy 26 is delivered ratably to system 10 so that the entire amount of total process energy 26 is transferred to system 10 by being metered out to vat contents 11a over the course of the cook cycle. Energy flow rate 32 is delivered at a substantially constant, steady-state rate. Flow rate 32 remains the same from beginning of cook cycle to end of cook cycle. In the embodiment illustrated in FIG. 2, energy flow rate 32 is preset by setting steam flow valve 14 to ratably deliver total process energy 26 over the cook cycle. Embodiments of process 10 use an open loop system. Prior art cooking process, such as that shown in FIG. 1, uses a closed loop system having temperature as a process variable. This results in variable energy delivery flow rates that affect product quality and value.

Process 10 is a function, among other things, of (i) specific heat of the cheese curd and whey 34 to be cooked and (ii) energy units required to be fed to the cheese curd and whey 34 over the cheese recipe cooking time. Process 10 delivers the required energy units to the cheese curd and whey 34 based on the difference between the temperature of the cheese curd and whey at inception of cooking and its temperature at completion of cooking. The temperatures at the start and at the end of the cheese cooking process are constants set by the particular cheese recipe in use.

Lost energy 27 to the atmosphere from vat 11 may be approximately calculated based upon the historic efficiency of the particular vat used. The baseline efficiency of vat 11 may, or may not, be provided in the manufacturer's specifications. For example, the vat's R-value may be given and an approximation of the efficiency may thereby be derived. While it is important to compensate for efficiency of vat 11, it is the efficiency of the entire heat transfer system that must be determined for a more accurate estimate of heat loss. Steam lines 13 and various valves and other components are also heat loss radiators. It would be difficult to arrive at a separate approximation of lost heat energy 27 from each of these parts of system 10. Therefore, historic efficiency of the entire system provides more accurate delivery of total process heat energy 26 to vat contents 11a than does reliance on the manufacturer's specifications and theoretical calculations alone. Historic efficiency is also an approximation, but it is a far better approximation than the manufacturer's specifications and theoretical calculations.

System 10 delivers the calculated total process heat energy 26 to cheese ingredients 35 beginning at the appointed cook start time. During the cooking process, system 10 tracks the actual, measured lost heat energy 27 occurring over the course of a cheese batch cook cycle and uses any deviations from the calculated lost heat energy 27 to adjust the calculated lost heat energy 27 accordingly during the next cheese batch cook cycle. Actual lost heat energy for each subsequent batch are also analyzed and used to modify the calculated, predetermined total process heat energy 26 input. This achieves a more precise estimate of the total process heat energy 26 per unit of time that must be delivered to vat jacket 16 to raise the temperature of vat contents 11a from the start temperature to the recipe's end temperature during the recipe cook cycle time. Process 10 produces a very even delivery of heat energy to vat 11 over the cooking time. It eliminates hot periods and inconsistent periods of energy delivery. The even flow of heat into cheese curd and whey 34 optimizes cheese recipes for (i) yield, (ii) product characteristics, and (iii) lower standard deviations in product analytics, all of which drives increased product revenues.

As illustrated in FIG. 2, system 10 includes a jacketed vat 11. Vat jacket 16 is comprised of outer jacket wall 16a and inner jacket wall 16b. Typically, vats are well insulated around outer jacket wall 16a, thereby minimizing heat loss to the atmosphere. In one embodiment, the heat substrate is steam—a high mass energy substrate. Steam from steam source 12, such as a conventional boiler, enters cooking system 10 and flows into jacket 16 via steam lines 13a and 13b. Steam lines 13, 13a, and 13b may, or may not, be insulated. Along steam line 13 are various indicating and control elements. Steam flow valve 14 is pre-set, prior to beginning cook process 10, to the steam energy flow rate 32 through steam lines 13, 13a, and 13b so that the required rate of steam flow is maintained at the system preset level. Steam from steam source 12 is at a constant pressure, thus steam temperature is known without need for a temperature sensor. Flow element 15 senses the amount of steam flow in steam lines 13, 13a, and 13b and the sensed amount is transmitted by flow transmitter 15a, via wire 19b, to PLC 22. PLC 22 compares the actual steam energy flow rate 32 to the preset steam energy flow rate 32 stored in PLC 22. If the actual steam energy flow rate 32 differs from the preset level, PLC 22 signals steam flow control valve 14, via wire 19a, to adjust the steam energy flow rate 32 to meet the preset, steam energy flow rate 32.

Steam condensate exits vat jacket 16 through steam condensate return line 17 to condensate tank 21 and is returned by pump 20 to steam source 12. The temperature of steam condensate leaving vat jacket 16 is monitored by temperature element 18. Steam condensate temperature is captured by PLC 22 and stored for later incremental adjustment of the calculated energy units required to cook the next batch of cheese, in accordance with the recipe. The condensate temperature indications are transmitted, via wire 19, to PLC 22.

Steam source 12 may be a conventional, commercially available steam boiler that provides the maximum steam output required by cheese cooking system 10. An embodiment of system 10 uses a vat commercially available from Tetra Pak Processing Systems Americas, Inc.

An embodiment of process 10 uses a PLC available from Relco Unisystems Corp., 2281 3^{rd} Avenue Southwest, Willmar, Minn. Minn. 56201. It is sold under the trademark, Reltronix®.

Data, such as process parameters, are entered into a computing device 24 for calculating, for example, the constant, steady-state level of total process energy 26 per unit of time that must be delivered to system 10 for cooking vat contents 11a according to recipe 33. Computing device 24 is interconnected to, and is a part of, system 10. Computing device 24 downloads to PLC 22 the pre-determined energy flow rate 32, which over the course of the cook time will be substantially equal to total process energy 26, required to be delivered to system 10 for cooking vat contents 11a in accordance with the recipe. Based upon the calculated energy flow rate 32 of total process energy 26 delivered to system 10, PLC 22 sets steam flow valve 14 to a full, or partially, open position, via wire 19a, that will allow the required amount of steam flow necessary to deliver the level, steady-state energy flow rate 32, per unit of time, that over the course of the recipe cook time will be substantially equal to calculated total process energy 26.

Process parameters that may be entered into system 10 by computing device 24 include (a) cheese weight; (b) cheese specific heat; (c) start temperature of cheese; (d) end temperature of cheese; (e) cooking time; (f) saturated steam gauge pressure; (g) various constants for calculation of required saturated steam temperature; (h) various constants based upon historic heat losses from system 10 (“lost energy 27”); (i) condensate return temperature; and (j) a correction factor (“correction factor energy 28”).

The amount of steam delivered to system 10 during the cook cycle of each batch of cheese is transmitted to PLC 22, via wire 19c. It uses the information to adjust, or correct, the calculation of total process energy 26 required for a subsequent cheese batch. The amount of steam delivered to system 10 is recorded by in-line steam meter 25. Initial correction factor energy 28 is based upon the amount of steam delivered during the initial cheese batch cook cycle. Correction factor energy 28, as well as the resulting calculation of total process energy 26 for subsequent batches, correlates solely to the same vat. A new correction factor energy 28 is determined for each batch of cheese made subsequent the previous batch.

Program instructions entered into computing device 24 are: (a) Net Energy 29=ingredient weight×ingredient specific heat×(cooked cheese temperature−uncooked cheese temperature); (b) conversion factor for converting net energy 29 into btu/hour; (c) Saturated Steam Temperature F=32° F.+1.8° F.×(constant B/(constant A−natural log pressure))−constant C; (d) Lost Energy 27 (“water enthalpy 30”)=constant 1×(constant 2+constant 3×saturated steam temperature C+constant 4×saturated steam temperature² C−constant 5×saturated steam temperature³ C); (e) Lost Energy 27 (“condensate enthalpy 31”) (btu/lb)=condensate return temperature F−32° F.; (f) adjustment of net energy calculation for lost energy 27 due to water enthalpy 30 and condensate enthalpy 31; and (g) Correction Factor Energy 28=actual, historical energy usage during prior batch of cheese.

After the cheese is removed from vat 11, a “clean-in-place” system may be activated to thoroughly wash, rinse and clean vat 11 and all other surfaces that contact the cheese, after which system 10 is ready for the next batch. All vat surfaces in contact with cheese ingredients 35 and cooked cheese are stainless steel.

Embodiments of process and system 10 comprise one or more recipes, each with one or more steps, for cooking curds and whey 34 to produce cheese. Three of the recipes start cooking the curds and whey 34 at 88° F., continue cooking for 600 seconds, and are designed for a batch of 46,000 pounds of curds and whey. The first recipe ends cooking (ceases delivery of heat to the vat contents 11a) after vat contents 11a reaches 92° F. The second recipe ends cooking at 96° F. and the third recipe ends at 101° F. Differing cook end point temperatures may be set for different cheese types, ingredient quality, and usage (such as pizza cheese).

A determination of the net energy 29 units required to cook a vat 11 of cheese is the product of the amount of cheese to be cooked multiplied by the specific heat of the combined ingredients 35 multiplied by the difference between the temperature of the ingredients 35 when cooking is complete less the temperature of the ingredients 35 when cooking is started. This is stated as:

Net Energy=Ingredient Weight×Ingredient Specific Heat×(Cooked Cheese Temperature−Uncooked Cheese Temperature).

An example of a determination of the net energy 29 units needed to cook a vat 11 of cheese is:

Net Energy=46,000 lbs×0.93×(92° F.−88° F.)=171,120 btu.

The amount of net heat energy 29 over the cooking process time is converted into btu/hour, i.e., the energy flow rate 32. Net energy 29 of 171,120 btu, determined in the previous paragraph, is delivered linearly over the cook time period. Therefore, net energy 29 per unit of time must be calculated to determine net energy flow rate 32 at which net energy 32 will be transferred from vat jacket 16 to vat contents 11a. Assuming a time of 600 seconds for a typical cheese cook step, the number of btu that must be delivered to system 10 per hour is calculated to be 1,026,720 btu/hr (net energy 29 of 171,120 btu divided by the product of 600 seconds×60 seconds per minute×60 minutes per hour). However, net energy 29 transferred to system 10 can be adjusted to account for lost energy 27 and other factors as discussed below. The adjustments make the cook process more precise and the final cheese product is better.

In an embodiment of process 10, steam is used for the source of energy units. The temperature at which saturated steam must be inputted into vat jacket 16 to transfer net energy 29 units required to cook the cheese is determined in accordance with:

Saturated Steam Temperature F=32° F.+1.8° F.×(constant B/(constant A−natural log pressure))−constant C.

Constants A, B, and C are relative to the log pressure used to solve for “super heat energy” within the steam under pressure. Assuming constants A, B, and C are respectively 23.1964, 3816.44, and 227.02 and the saturated steam gauge pressure is at 60 psig, the saturated steam temperature in Fahrenheit required to deliver 1,026,720 btu/hr is calculated as follows:

Saturated Steam Temperature F=32° F.+1.8° F.×(3816.44/(23.1964−natural log pressure))−227.02,

which results in a saturated steam temperature of 307.28° F.

Heat loss due to energy leaving system 10 includes losses to surrounding air (water enthalpy 30 losses), primarily from vat 11, and losses (condensate enthalpy 31 losses) due to heat energy remaining in condensate exiting vat jacket 16.

Lost heat energy 27 leaving vat 11 and other system components, such as steam lines 13 and valving, to surrounding air is calculated by determining water enthalpy energy 30 in heat energy units per pound leaving system 10. The calculation is dependent upon various factors relating primarily to historic heat loss from vat 11. These factors are taken into consideration when calculating water enthalpy energy 30 in the form of constants. Using constants 1, 2, 3, 4, and 5, lost energy 27 leaving vat 11 is determined by:

Lost Energy 27 (btu/lb)=constant 1×(constant 2+constant 3×saturated steam temperature C)+constant 4×saturated steam temperature² C)−constant 5×saturated steam temperature³ C).

For example, lost heat energy in the form of water enthalpy energy 30, in heat energy units per pound, leaving system 10 with steam at 60 psig, is:

Lost Heat Energy (btu/lb)=0.42992×(2502.19+1.772251×152.93 C+0.001015186×23387.5849−0.0000133367×357663.359),

which is 1,181.96 btu/lb.

Lost heat energy 27 leaving vat jacket 16 as condensate is calculated using condensate enthalpy energy 31 in heat energy units per pound of condensate leaving system 10. Condensate enthalpy energy 31 is a function of the condensate return temperature. Lost heat energy 27 leaving system 10 due to the return of condensate enthalpy 31 to boiler 12 in btu/lb is determined by:

Condensate Enthalpy 31 (btu/lb)=condensate return temperature F−32° F.

A typical example is:

Condensate Enthalpy (btu/lb)=120−32,

which is 88 btu/lb.

To make up for lost heat energy 27 from vat 11 and vat jacket 16, an amount of heat energy equivalent to the lost heat energy 27 must be added to net energy 29. Lost heat energy 27 from vat 11 is 1,181.96 btu/lb and from condensate leaving vat jacket 16 is 88 btu/lb (condensate leaving vat jacket 16 is not an actual loss from system 10 because the condensate returns to boiler 12 and adds to its ultimate energy output). An example of the amount of lost energy 27 units in btu/hour that must be added to net energy 29 in btu/hour is:

Lost Energy btu/hour=2,076,464 btu/hour/(1,181.96 btu/lb−88 btu/lb),

which is 1,898.1169 btu/hour.

The total process energy 26 that must be delivered to system 10 is 1,028,618 btu/hour, which includes the previously calculated amount of (i) 1,026,720 btu/hour (net energy 29) and (ii) 1,898 btu/hour (lost energy 27).

System 10 delivers the 1,028,618 btu/hour of total process energy 26 to cheese ingredients 35 beginning at the appointed cook start time. During the cooking process, system 10 tracks the actual deviation from total process heat energy 26 and uses the deviations to adjust total process energy 26 for the next batch of cheese. In-line steam meter 25 tracks the total pounds of steam added to vat contents 11a. Using the output from in-line steam meter 25, system 10 calculates actual (i) total process energy 26 units added to vat jacket 16 and (ii) exiting condensate enthalpy energy 31 leaving vat jacket 16 into condensate line 17. System 10 then compares calculated total process energy 26 that was to be delivered to vat contents 11a and determines whether actual total process energy 26 was more or less than the calculated amount. If actual total process energy 26 of the previous batch, or batches, was different than the calculated amount of the previous batch, or batches, an efficiency factor can be calculated. The efficiency of system 10 for cooking a previous, single batch of cheese is determined according to the following:

Efficiency Factor=1−(actual energy units short or long divided by calculated total process energy 26 units).

As previously discussed, the amount of actual energy units short or long, i.e., the correction factor energy 28, is added or subtracted to net energy, as well as the other factors described herein, to calculate required total process energy 26 for the next batch of cheese.

Even though numerous characteristics and advantages of the various embodiments are set forth in the foregoing description, together with details of the structure and function of various embodiments, this description is illustrative only. Changes may be made in detail of the embodiments and/or the principles set forth in this description to the fullest extent, within the scope of the broad general meaning of the appended claims.

What is claimed is:

1. A process of making cheese comprising the steps of:
(a) creating a recipe for making cheese, the recipe comprising (i) curds and whey as the ingredients, (ii) the temperature of the ingredients at start and at the end of the cook cycle, (iii) the elapsed time from the start to the end of the cook cycle, (iv) the mass of ingredients, (v) the steady-state energy flow rate over the elapsed time from the start to the end of the cook cycle, and (vi) the temperature of the saturated steam required to transfer the steady-state energy flow rate to ingredients; and
(b) delivering the steady-state energy flow rate to the ingredients through the medium of saturated steam.

2. The process of claim 1, wherein the steady-state energy flow rate is determined by the steps comprising:
(a) calculating the net energy as the product of the mass of the ingredients multiplied by the specific heat of the ingredients multiplied by the difference between the temperature of the ingredients at the end of the cook cycle and the temperature of the ingredients at the start of the cook cycle;
(b) calculating the lost water enthalpy energy;
(c) calculating the lost condensate enthalpy energy;
(d) calculating the correction factor energy;
(e) summing the foregoing net energy, lost water enthalpy energy, lost condensate enthalpy energy, and correction factor energy to arrive at the total process energy; and
(f) by dividing the total process energy by the elapsed time from the start to the end of the cook cycle.

3. A system for making cheese with a substantially invariable energy transfer according to the process of claim 1, comprising:
(a) a vat for containment of curds and whey ingredients;
(b) a source of saturated steam at a constant pressure;
(c) a jacket on the vat adapted to transfer energy from the saturated steam to the ingredients;
(d) a means for circulating the saturated steam throughout the jacket; and
(e) a means for maintaining a predetermined steady-state energy flow rate in the jacket during the pre-determined cook time.

4. A process of making cheese comprising the steps of: (a) providing a recipe for making cheese; (b) determining total process energy required to cook cheese ingredients according to the recipe; and (c) transferring total process energy to the ingredients.

5. The process of claim 4, wherein the recipe comprises: (a) temperature of ingredients at start of cook cycle; (b) temperature of ingredients at end of cook cycle; (c) elapsed time from start to end of cook cycle; and (d) mass of ingredients.

6. The process of claim 5, wherein ingredients comprise curds and whey.

7. The process of claim 4, wherein determining total process energy comprises the step of calculating net energy as product of mass of ingredients multiplied by specific heat of ingredients multiplied by difference between temperature of ingredients at end of cook cycle and temperature of ingredients at start of cook cycle.

8. The process of claim 7, wherein determining total process energy also comprises the step of determining lost water enthalpy energy.

9. The process of claim 7, wherein determining total process energy also comprises the step of determining lost condensate enthalpy energy.

10. The process of claim 7, wherein determining total process energy also comprises the step of determining correction factor energy.

11. The process of claim 4, wherein determining total process energy comprises the step of summation of net energy; lost water enthalpy energy; lost condensate enthalpy energy; and correction factor energy.

12. The process of claim 4, comprising the step of determining the steady-state energy flow rate.

13. The process of claim 11, wherein determining energy flow rate comprises the step of dividing total process energy by recipe cook time.

14. The process of claim 12, wherein transferring total process energy to ingredients comprises the step of transferring saturated steam to the ingredients.

15. The process of claim 14, comprising the step of determining the temperature of the saturated steam required to transfer the total process energy to the ingredients.

16. A system for making cheese, comprising (a) a container; (b) the container containing contents; (c) a jacket; (d) the jacket having an input port and an output port; (e) a source of energy; (f) a means for transferring energy from the source to a substrate; (g) the input port for receiving the substrate containing energy; (h) the jacket adapted to transfer energy contained in the substrate to the container contents; (i) the output port for discharging substrate containing less energy than the energy contained in the substrate at the input port; (j) a means for determining total process energy required to process the contents; (k) a means for setting a constant rate of flow of total process energy through the jacket over a pre-determined period of time; (l) the pre-determined period of time having a pre-determined start temperature and stop temperature.

17. The system of claim 16, wherein the container comprises a vat.

18. The system of claim 16, wherein the contents comprises curds and whey.

19. The system of claim 16, wherein the jacket adapted to transfer energy to the container comprises a jacket that is in contact with at least a portion of container.

20. The system of claim 16, wherein the source of energy comprises heat energy.

21. The system of claim 16, wherein the means for transferring energy from the source to a substrate is a boiler.

22. A system for making cheese from curdled cheese milk by cooking the curdled cheese milk, until it turns into cheese, with a substantially invariable transfer of energy to the curdled cheese milk, comprising (a) a vat for holding curdled cheese milk; (b) a vat jacket; (c) a constant pressure steam source, and thereby a known steam temperature; (d) a steam line connected from the constant pressure steam source to a steam flow valve, the steam flow valve set, prior to commencement of the cook process, to a pre-determined steam energy flow rate for the duration of the cook cycle; (e) the pre-determined steam energy flow rate stored in a computing device; (f) a steam line connected from the steam flow valve to a steam flow element; (g) the steam flow element configured for sensing the steam energy flow rate through the steam flow element; (h) a means for transmitting the sensed steam energy flow rate through the steam flow element to a computing device; (i) the computing device configured to compare the sensed steam energy flow rate to the pre-determined steam energy flow rate; (j) a means to direct the steam flow element to adjust the sensed steam energy flow rate to the pre-determined steam energy flow rate, if there is a difference between them; (k) a steam line connected from the steam flow element to the vat jacket; (l) a condensate drain; and (m) the following additional parameters stored in the computing device—cheese weight, cheese specific heat, start and end temperatures of the cheese cook cycle, cooking time, saturated steam gauge pressure, constants for calculation of the required saturated steam temperature, lost energy, and correction factor energy.

23. The system of claim 22, wherein the vat has a means for mixing the curdled cheese milk.

24. The system of claim 22, also comprising: (a) the condensate drain configured to return the condensate to a condensate tank; (b) a means for returning the condensate from the condensate tank to the constant pressure steam source; (c) a means for measuring the steam temperature of the condensate exiting the vat jacket; and (d) a means for sending the steam temperature of the condensate exiting the vat jacket to a computing device for storage for later incremental adjustment of the calculated energy units required to cook subsequent batches of cheese in accordance with the recipe.

25. The system of claim 22, also comprising a means for measuring the temperature of the vat contents during the cook time.

26. A system for cooking cheese with a substantially invariable energy transfer to curdled cheese milk, comprising (a) a recipe for making cheese; (b) a means for storage of, and access to, the process parameters of the recipe; (c) a means for determining the total process energy required to cook the cheese according to the recipe; (d) a means for determining the steady-state energy flow rate required to cook the cheese during the cook cycle; (e) a means for maintaining the steady-state energy flow rate constant during the cook cycle; (f) a means for transferring the steady-state energy flow rate to the ingredients of the recipe during the cook cycle; and (g) a means for delivering constant pressure steam to the means for transferring the steady-state energy flow rate to ingredients of the recipe during the cook cycle.

27. The system of claim 26, wherein the cheese recipe comprises the total process energy required to cook the cheese ingredients, the temperature of the ingredients at the start and the end of the cook cycle; the elapsed time from the start to the end of the cook cycle; the mass of the ingredients, the specific heat of the ingredients, the steady-state energy flow rate, the pressure of the saturated steam, the condensate return temperature, and the temperature of the saturated steam.

28. The system of claim 26, wherein the ingredients of the recipe are comprised of curds and whey.

29. The system of claim 26, wherein the means for storage of, and access to, the process parameters of the recipe is comprised of a computing device having storage means and instruction means.

30. The system of claim 26, wherein the means for determining the total process energy required to cook the cheese according to the recipe comprises determining (a) the net energy as product of the mass of the ingredients multiplied by the specific heat of the ingredients multiplied by the difference between the temperature of the ingredients at end of the cook cycle and the temperature of the ingredients at the start of the cook cycle; (b) the lost water enthalpy energy; (c) the lost condensate enthalpy energy; (c) the correction factor energy; and (d) the sum of the net energy, the lost water enthalpy energy, the lost condensate enthalpy energy, and the correction factor energy.

31. The system of claim 26, wherein the means for determining the steady-state energy flow rate required to cook the cheese during the cook cycle comprises dividing total process energy by recipe cook time.

32. The system of claim 26, wherein the means for maintaining the steady-state energy flow rate constant during the cook cycle is comprised of (a) a steam flow rate element in a steam line, the steam flow rate element configured for sensing the steam flow rate through the steam flow rate element; (b) a means for transmitting the sensed steam flow rate to a computing device; (c) the computing device configured to compare the sensed steam flow rate to the pre-determined steam flow rate; (k) the computing device configured to instruct the steam flow rate element to adjust the sensed steam flow rate to the pre-determined steam flow rate, if there is a difference between them.

33. The system of claim 26, wherein the means for transferring the steady-state energy flow to the ingredients of the recipe during the cook cycle is comprised of a jacket for thermally conducting the steady-state energy flow into the ingredients.

34. The system of claim 26, wherein the means for delivering constant pressure steam during the cook cycle is comprised of a constant pressure steam source connected to the system steam lines, valves, sensors, and jacket.
